(19) United States
(12) Patent Application Publication
(10) Pub. No.: US 2013/0321754 A1
(43) Pub. Date: Dec. 5, 2013

(54) Fumed Metal-Oxide Gel-Dispersed Blue-Phase Liquid Crystals and Devices Thereof

(71) Applicant: Kent State University, Kent, OH (US)

(72) Inventors: Liang-Chy Chien, Hudson, OH (US); Jeoung-Yeon Hwang, Kent, OH (US)

(21) Appl. No.: 13/905,725

(22) Filed: May 30, 2013

Related U.S. Application Data
(60) Provisional application No. 61/653,002, filed on May 30, 2012.

(51) Int. Cl. G02F 1/139

(52) U.S. Cl. CPC G02F 1/1396
USPC 349/179; 252/500

(57) ABSTRACT

The present invention comprises a fumed metal-oxide gel, such as fumed silica gel, that is dispersed into a blue-phase liquid crystal. Adding the fumed silica nanoparticles in blue-phase media leads to the broadening of the blue-phase temperature range and reduces the switching voltage. Additionally, the polarity-controlled nanoparticles of the fumed silica enable the stabilization of thermal-sensitive Bragg reflection property of the blue-phase liquid crystals, which allows their use in active optical elements and fast-switching LCDs.

### CROSS-REFERENCE TO RELATED APPLICATION

This application claims the benefit of U.S. Provisional Application No. 61/653,002 filed May 30, 2012, the contents of which are incorporated herein by reference.

### TECHNICAL FIELD

The present invention relates to blue-phase liquid crystal dispersions. In particular, the present invention relates to fumed metal-oxide gel and blue-phase liquid crystal dispersions. More particularly, the present invention relates to fumed metal-oxide gel dispersed blue-phase liquid crystals to provide fast-switching liquid crystal displays (LCDs) having a wide viewing angle, and low switching voltage.

### BACKGROUND ART

As high definition liquid crystal displays (LCD) become popular, demand for even higher picture quality, wider viewing angles, lower power consumption, and faster switching time continue to rise. LCDs with fast motion picture response time (MPRT) that allow for the display of fast action scenes have long been sought after. To improve the relatively slow dynamics of nematic liquid crystals (LCs), advances in liquid crystal materials have been made, along with the utilization of new approaches of controlling the liquid crystal. For example, techniques to improve motion and hold-type blur of LCDs have been developed and include scanning backlights, frame rate doubling, and black data insertion for example.

Blue-phase (BP) liquid crystals are known to take on an optically-isotropic phase having unique physical and optical properties for device applications. For example, blue-phase liquid crystals, require no alignment layers, provide field-induced electrostriction for color tuning and have fast switching for field switched birefringence (i.e. Kerr effect). Cholesteric blue-phase liquid crystals are locally isotropic fluids in which the molecules organize themselves into complex, three-dimensional structures characterized by crystallographic space group symmetry. Hence, blue-phase liquid crystals form as double-twisted cylinders separated by defect lines, and effectively, it is the network of the defect lines, which characterizes the blue-phase liquid crystals. Since the cholesteric blue-phase liquid crystals display cubic symmetry with a lattice constant of several hundred nanometers, and because they are fluids, their structure can be easily manipulated. Therefore, the properties of blue-phase devices are widely tunable, which is highly desirable.

One approach for improving the typically narrow blue-phase temperature range was developed, which utilizes a polymer to stabilize the defect cores of the cubic lattice.

Indeed, the polymer-stabilized blue-phase (PSBP) liquid crystals showed not only a broad blue-phase temperature range, but also a fast response time that is less than a microsecond of electric field-induced birefringence in an optical Kerr device, such as a nematic LCD. Such response time of the polymer-stabilized blue-phase (PSBP) liquid crystal is an order of magnitude faster than the response times of 8-20 ms provided by nematic liquid crystal based displays, such as twisted nematic (TN), super polydomain vertically aligned (SVA) nematic, and super in-plane-switching (SIPS) displays.

The PSBP liquid crystals, such as low molar mass blue-phase (BP) liquid crystals, require no surface treatment for use in LCD applications because of its symmetrical structure and its optically isotropic properties in the field-off state. Due to the fast switching of PSBP liquid crystals, there is a strong desire to implement such features into next-generation LCDs and devices. However, current implementations of blue-phase liquid crystal materials suffer from several drawbacks, which are unwanted.

Therefore, there is a need for fumed metal-oxide gel-dispersed blue-phase liquid crystals to provide fast-switching electro-optical devices. In addition, there is a need for fumed metal-oxide gel-dispersed blue-phase liquid crystal that utilizes nanoparticles to broaden the blue-phase temperature range and reduce the switching voltage for a fast switching Kerr-device, such as an LCD. In addition, there is a need for fumed metal-oxide gel-dispersed blue-phase liquid crystals, whereby polarity-controlled nanoparticles enable the stabilization of the thermal-sensitive Bragg reflection property, which allows the blue-phase liquid crystal to serve as active optical elements and fast-switching displays and devices.

### SUMMARY OF THE INVENTION

In light of the foregoing, it is a first aspect of the present invention to provide a method of producing a blue-phase liquid crystal comprising the steps of providing a nematic liquid crystal material; providing a chiral dopant material; providing fumed metal-oxide nanoparticles; and mixing the nematic liquid crystal material, the chiral dopant material, and the fumed silica nanoparticles.

It is another aspect of the present invention to provide an electro-optical device comprising first and second substrates separated to define a gap between the substrates; a liquid crystal composition disposed in the gap, the liquid crystal composition comprising a blend of nematic liquid crystals, at least one chiral dopant, and fumed metal-oxide nanoparticles; and a pair of electrodes patterned on an inner surface of the first substrate to provide an electric field to switch the liquid crystal composition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features and advantages of the present invention will become better understood with regard to the following description, appended claims, and accompanying drawings wherein:

FIG. 1a is a schematic view of an electro-optical (E-O) cell using fumed metal-oxide gel-dispersed blue-phase liquid crystals showing a substrate of the cell patterned with interdigitated electrodes in accordance with the concepts of the present invention;

FIG. 1b is a cross-sectional view of the electro-optical (E-O) cell using fumed metal-oxide gel-dispersed blue-phase liquid crystals with an applied in-plane electric field in accordance with the concepts of the present invention;

FIG. 1c is a top view of the assembled electro-optical (E-O) cell using fumed metal-oxide gel-dispersed blue-phase liquid crystals in accordance with the concepts of the present invention;

FIGS. 2a-b are polarizing optical microscope (POM) micrographs for hydrophobic AG-d-BD samples (FIG. 2a), and hydrophilic AG-d-BP samples (FIG. 2b) at different Aerosil® gel concentrations, where the images were obtained from cooled AG-d-BP samples at a rate of 0.2° C./min in accordance with the concepts of the present invention;

FIGS. 3a-b are charts showing the temperature dependence of the Bragg refection peak wavelength based on the concentration of hydrophobic AG-d-BP samples (FIG. 2a) and hydrophilic AG-d-BP samples (FIG. 2b) in accordance with the concepts of the present invention;

FIGS. 4a-b are charts showing the transmittance and voltage as a function of the concentration of hydrophilic AG-d-BP samples (FIG. 4a), and showing the response time (rising and falling time) as a function of the concentration of hydrophilic AG-d-BP samples (FIG. 4b) in accordance with the concepts of the present invention; and

FIGS. 5a-b are charts showing the normalized transmittance and voltage as a function of the concentration of the hydrophobic AG-d-BP samples (FIG. 5a), and showing the response time (rising and falling time) as a function of concentration of the hydrophobic AG-d-BP samples (FIG. 5b) in accordance with the concepts of the present invention.

### DETAILED DESCRIPTION OF THE INVENTION

The present invention is directed to the use and fabrication of fumed metal-oxide gel-dispersed blue-phase (BP) liquid crystals to form liquid crystal displays (LCD) and other electro-optical devices. However, while the present invention contemplates the use of any suitable fumed metal-oxide particles to form the fumed metal-oxide gel-dispersed blue-phase (BP) liquid crystals, including but not limited to, Al₂O₃, MgO, ZrO₂, CeO₂, TiO₂, ZnO, Fe₂O₃, SnO, NiO, ZrO₂, MoO₃, CeO₂, Y₂O₃, the following discussion presents the use of fumed silica (i.e. amorphous silicon dioxide particles) sold under the name Aerosil® by Evonik Industries AG, to form the fumed metal-oxide gel-dispersed blue-phase (BP) liquid crystals, hereinafter referred to as AG-d-BP liquid crystals. However, before presenting the details relating to the manner of producing Aerosil® gel-dispersed blue-phase (BP) liquid crystals or AG-d-BP, a brief discussion of the properties of Aeorsil will be provided to assist the reader in understanding the present invention.

In particular, fumed silica (amorphous silicon dioxide) nanoparticles, such as Aerosil®, may be made by flame pyrolysis of silicon tetrachloride or made from quartz sand that is vaporized in a 3000° C. electric arc. Aerosil® has an extremely low bulk density and high surface area, and its three-dimensional structure results in viscosity-increasing, thixotropic behavior when it is utilized as a thickener or reinforcing filler. As such, Aerosil®, due to its properties, is widely used in the production of various items, including yachts, building materials, paints and coatings, adhesives and sealants, batteries, electronics, dye-sensitized solar cells, glass, lighting, papers, personal care, pharmaceuticals, plastics, rubber, and toners for example. Finally, Aerosil® is provided in both hydrophilic and hydrophobic formulations, as will be discussed in further detail below.

Thus, Aerosil® dispersed liquid crystals are particularly attractive materials due to their ability to impart changes in the physical behavior of liquid crystals (LCs) that are caused by the random disorder introduced in the bulk liquid crystal molecules. Many studies have been done on Aerosil®-dispersed nematic liquid crystals, and thus, it is known that liquid crystals with a strong dipole moment when dispersed with Aerosil® show strong surface-related interactions between the host and guest nanoparticles. Hydrophilic Aerosil® has a high surface energy, which arises from the hydroxyl groups at their surface, whereas the hydrophobic Aerosil® has a low surface energy due to the long hydrocarbon side chains, such as those of attached to polyimide for homeotropic liquid crystal alignment.

In the present invention, a new electro-optical effect in Aerosil® gel-dispersed blue-phase (AG-d-BP) liquid crystals is achieved. Specifically, Aerosil® gels dispersed in blue-phase liquid crystals modify the surface tension between the cholesteric helix and the disclination cores or voids of the cubic lattice of the cholesteric liquid crystal. Depending on the polarity of the Aerosil® molecules, which include a non-polar state with dangling hydrocarbon chains or a polar state with silanol groups, strong interactions between the host molecules and guest nanoparticles leads to the broadening of the blue-phase temperature range. Depending on the polarity of the liquid crystal (LC) molecules, hydrogen bonds may occur between the silica colloids and the liquid crystal. In such cases, polar ordering may also arise in the surface layers around the Aerosils®. This process is more understandable in Aerosils® with dangling silanol groups in which hydrogen bonding can lead to diffusion-limited aggregation, if the silica density exceeds the gelation threshold. Thus, the discussion that follows presents the manner for making and implementing Aerosil®-dispersed blue-phase liquid crystals or AG-d-BP liquid crystals, in addition to presenting the optical/electro-optic performance characteristics of such Aerosil®-dispersed blue-phase liquid crystals.

The composition of Aerosil® gels dispersed in a blue-phase liquid crystal (BPLC) dispersion can be varied from 0.000001 to 90 percent by the weight of the BPLC. A representative mixture of a blue-phase liquid crystal (BPLC) is prepared by mixing a nematic liquid crystal (NLC) (55.0% of BL006, sold by Merck or any other suitable NLC at a desired concentration) with a chiral dopant (45.0% of R811, sold by Merck or any other suitable dopant at a desired concentration). It should be appreciated that in one aspect, the chiral dopant may include any suitable material such as C15, CB15, CE1, CE2, CE4, CE5, CE6, CE9, S/R811, and S/R1011 for example. The addition of hydrophilic-fumed silica (Aerosil® type 200) and hydrophobic-fumed silica (Aerosil® type 812) was aimed to increase the blue-phase (BP) temperature range of the liquid crystal material, and lower the operating voltage of the blue-phase liquid crystal (BPLC) device. The doped BPLC sample materials were prepared by adding about 0.02 wt %, 0.05 wt %, 0.1 wt %, and 0.6 wt % of corresponding hydrophilic and hydrophobic Aerosil® fumed silica in the blue-phase (BP) mixture respectively, while keeping the nematic and chiral dopant concentrations at a constant ratio of about 1:0.8. In another aspect, it should be appreciated that the amount of the chiral dopant may be from about 0.1 to 90 parts by weight per 100 parts by weight of the nematic liquid crystal material. In yet another aspect, it should be appreciated that the amount of the fumed metal-oxide nanoparticles used, including the Aerosil® material, may be from about 0.000001 to about 10.0 parts by weight per 100 parts by weight of the nematic liquid crystal and the chiral dopant.

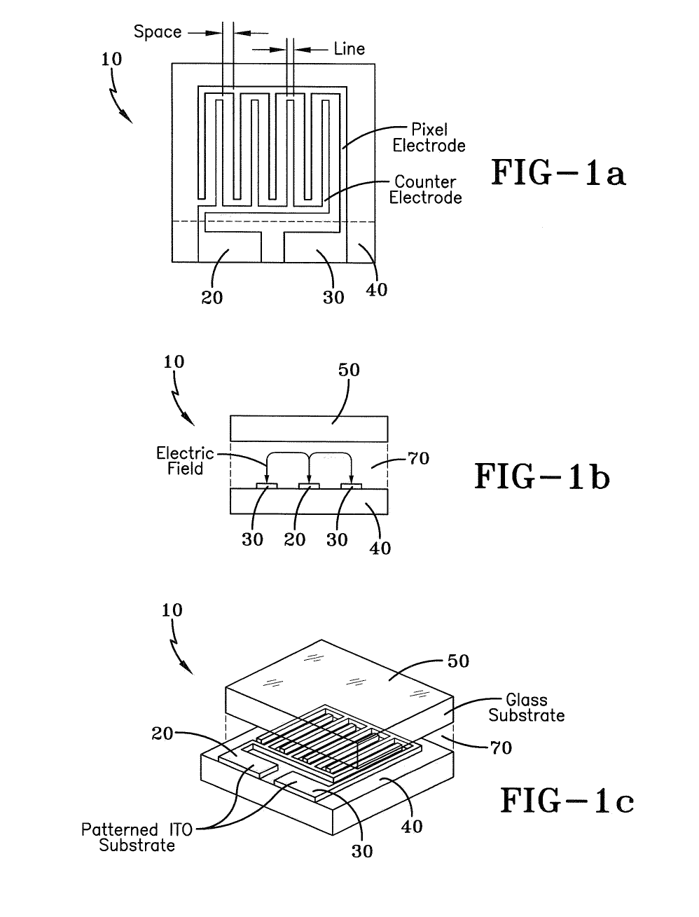

Electro-optical (E-O) cells 10, as shown in FIGS. 1a-c, were prepared using interdigitated indium-tin-oxide (ITO) electrodes 20 and 30 disposed on one coated substrate 40, while the other spaced substrate 50, which may comprise an at least partially transparent substrate, such as glass, had no electrodes disposed thereon. However, it should be appreciated that the substrate 40, as well as the electrodes 20,30, may also be formed of an at least partially transparent material as well. Electro-optical (E-O) measurements of field induced birefringence required the use of in-plane-switching (IPS) cells with patterned indium tin oxide (ITO) electrodes of 5, 7.5 or 10 μm electrode line and 5, 7.5 or 10 μm electrode space on one glass substrate. The IPS cells 10 were assembled with a second glass substrate, without ITO electrodes, using ball spacers (not shown) to separate the glass substrates with a cell gap of 5, 7.5 or 10 μm. Prior to filling the gap or space between the substrates 40,50 of the electro-optical cells 10 with the blue-phase liquid crystal material 70, the blue-phase liquid crystal material 70 samples were agitated in a sonicator at a constant temperature of 30° C. for 90 minutes. Through the use of capillary action the blue-phase liquid crystal (BPLC) material was filled into the cell 10 at an isotropic state and then allowed to slowly cool to the cholesteric phase. An E-O testing apparatus comprising a hellion-neon laser with light emission having a wavelength of about 633 nm, a pair of polarizers crossed at 90° with respect to the polarization axes, a diode detector, a computer controlled function generator and an amplifier were used for data acquisition. The E-O measurements were carried out by aligning the stripes of the electrodes 40 and 50 of the IPS cell 10 at a 45° angle between the 90° crossed polarizers. The measurements of light transmittance as a function of applied voltage curves and response times were carried out at a constant blue-phase (BP) state.

As shown in FIGS. 1a-c, the interdigitated electrodes 20 and 30, which are configured for applying an electric field in the plane of the substrate surface, as shown in FIG. 1b, were patterned so as to have a width of about 5 or 10 μm, and are spaced by about 5 or 10 μm. The electro-optical cells were assembled with another glass substrate without ITO electrodes, but using ball spacers to separate the glass substrates to form a cell gap of about 5 or 10 μm. Finally, the blue phase liquid crystal material was filled into Electro-optical (EO) cells 10 through a capillary action at the isotropic temperature of the BPLC.

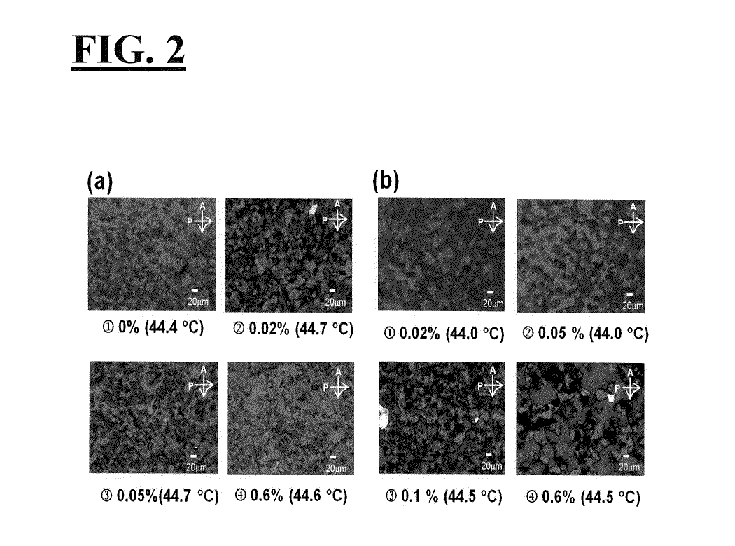

FIGS. 2a-b show polarizing optical microscope (POM) images that were acquired in the transmission mode at a similar temperature as a function of the concentration of both hydrophobic Aerosil®-gel dispersed blue-phase liquid crystals (FIG. 2a) and hydrophilic Aerosil®-gel dispersed blue-phase liquid crystals (FIG. 2b). In particular, the images shown in FIGS. 2a-b were obtained at a cooling rate of 0.2° C./min from the isotropic states of the AG-d-BP sample. Thus, it was observed that the size of the colored domain in the 0.02 wt % hydrophobic AG-d-BP sample was similar to that of pure blue-phase liquid crystal, and that the size of the colored domain in the hydrophobic AG-d-BP is slightly increased as the concentration of the hydrophobic Aerosil® gel is increased in the hydrophobic AG-d-BP samples. However, it was also observed that the size of colored domains in the 0.02 wt % hydrophilic AG-d-BP samples was larger than that of pure blue-phase liquid crystal. It was also observed that the size of the colored domains in the hydrophilic AG-d-BP samples increased as the concentration of the hydrophilic Aerosil® gel increased at similar temperatures. Finally, it was also observed that hydrophobic Aerosil® gel samples showed red colored domains, while samples of lower concentration hydrophilic Aerosil® gel (0.02 wt % and 0.05 wt %) did not show the appearance of the red colored domains. On the other hand, the 0.6 wt % hydrophilic AG-d-BP sample exhibited the highest concentration and size of red colored domain among the other samples at the same temperature. The different colored domains observed in AG-d-BP samples are believed to be attributed to the elongation of the cubic lattice constant. Finally, the increase in lattice constant leads to a red-shift in the Bragg reflected wavelength.

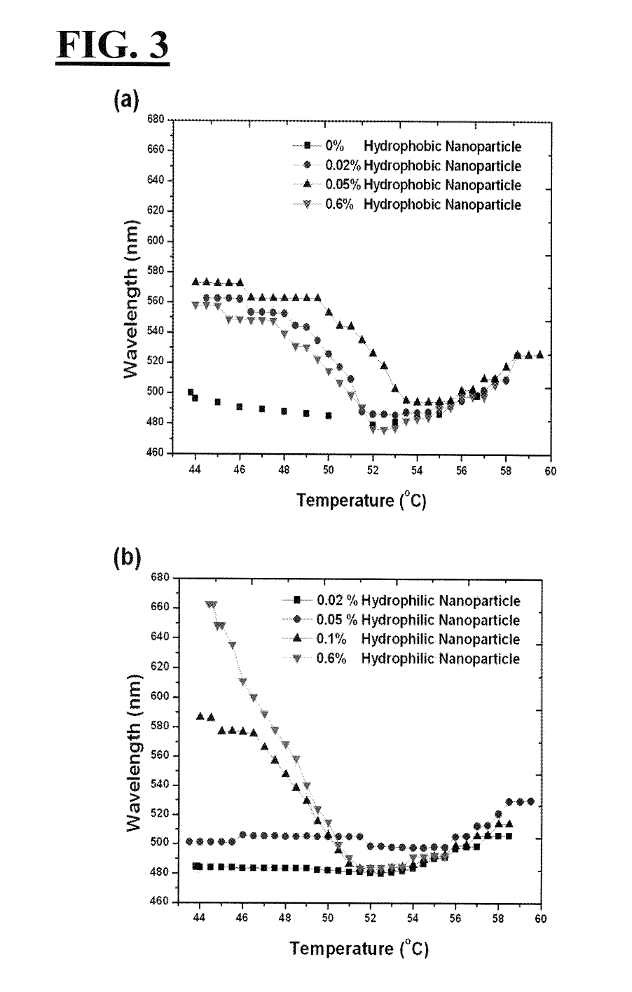

The charts shown in FIGS. 3a-b illustrate the temperature dependence of the peak reflection wavelength as a function of the concentration of hydrophobic (FIG. 3a) AG-d-BP liquid crystal and hydrophilic (FIG. 3b) AG-d-BP liquid crystal samples. Specifically, a red-shift in Bragg peak wavelengths (563 nm-573 nm) in the hydrophobic AG-d-BP samples was observed at all concentrations of Aerosil® gel, as shown in FIG. 3a. Compared to the pure blue-phase liquid crystal (BPLC), the temperature dependence of the Bragg peak wavelength shows a pattern with a slight blue-shift, then a red-shift, and then finally stabilization at a temperature between about 48° to 50° C., depending on the Aerosil® gel concentration. At the low concentration of hydrophilic Aerosil® gel dispersion, as shown in FIG. 3b, the AG-d-BP samples show a slight blue-shift at the phase transition from the isotropic phase to the blue-phase (BP) transition, while being stabilized against temperature fluctuation. In contrast to the low Aerosil® gel content, it is observed that a severe red-shift occurs with a 0.6 wt % hydrophilic AG-d-BP sample, which is similar to that of the hydrophobic AG-d-BP samples. This finding corroborates the polarizing optical microscopic (POM) image shown in FIG. 2b. This could be due to the saturation in hydrogen bonding between hydrophilic Aerosil® nanoparticles and the host liquid crystal.

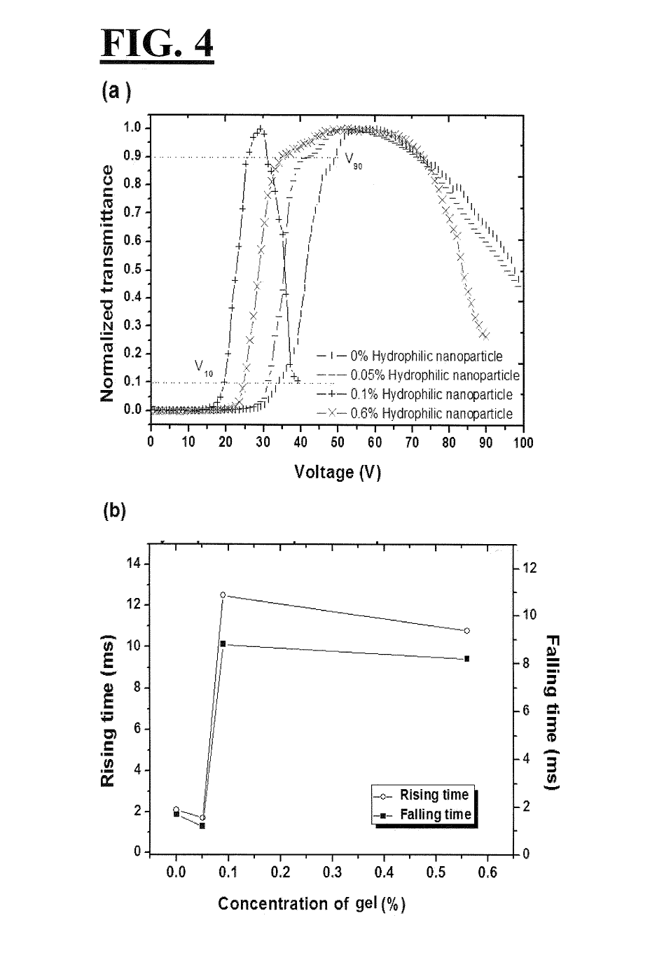

FIGS. 4a-b show charts of transmission versus voltage curves of hydrophilic AG-d-BP samples (FIG. 4a), and the rising/falling time for different concentrations of Aerosil® gel (FIG. 4b). Specifically, as shown in FIG. 3a, a reduction in the threshold voltage (V₁₀) of the hydrophilic AG-d-BP samples (V₁₀=19.5 V) compared to that of the pure blue phase (V₁₀=34.2V) is observed. Indeed, all the hydrophilic AG-d-BP samples show a reduction in both the threshold and turn on voltages, as compared to pure blue-phase liquid crystals (BPLC). The plot of the response time (rise and fall times) versus the concentration of Aerosil® gels of hydrophilic AG-d-BP samples are shown in FIG. 3b. The response time for 0.05% hydrophilic AG-d-BP sample is found as 2.9 ms. In the case of the hydrophilic nanoparticle doped samples, the response time was increased rapidly up to 0.1% nanoparticles and was leveled off at 0.6% nanoparticles, as shown in FIG. 4b. There is an increase in response time in the AG-d-BP samples with a gel concentration above 0.1% wt. This phenomenon is due to the increase in the viscosities of the composites.

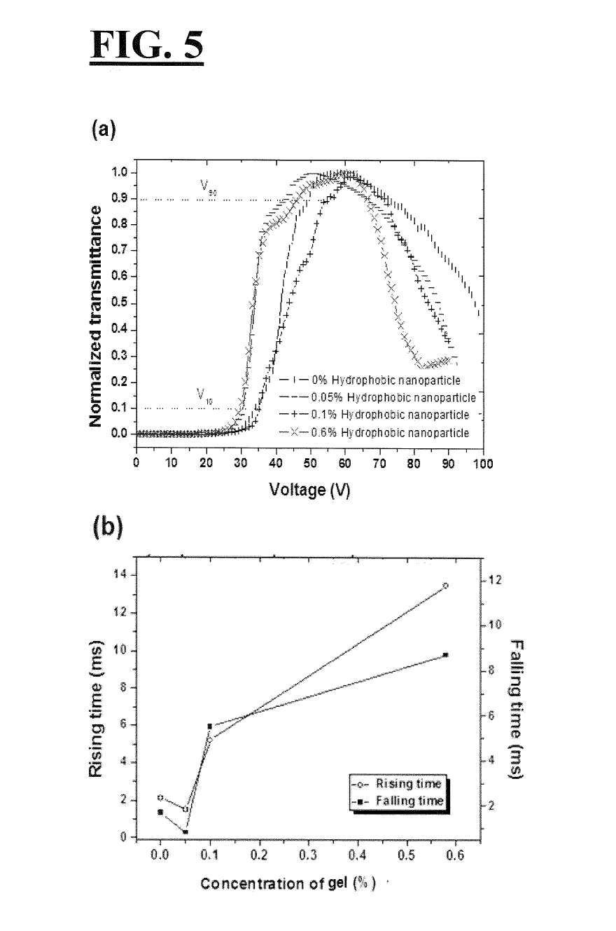

FIGS. 5a-b show the light transmission versus applied voltage curves of hydrophobic Aerosil® nanoparticles doped blue-phase liquid crystal (BPLC) samples (FIG. 5a) and the rising/falling time for different concentrations of Aerosil® gel (FIG. 5b). The results show a minor reduction in switching voltage in 0.05% and 0.6% hydrophobic Aerosil® gels dispersed blue-phase (BP) samples (FIG. 5b), but exhibit either minor reduction in response time for 0.05% concentration sample and significant increase in response times for samples with 0.1% and 0.6% hydrophobic Aerosil® gels dispersed BP samples. The results reveal that hydrophobic Aerosil® gels can reduce the switching voltage but not as effectively as the hydrophobic Aerosil® gels.

Therefore, one advantage of the present invention is that an Aerosil® gel-dispersed blue-phase liquid crystal material has a broad blue-phase temperature range with reduced switching voltage for a fast switching Kerr device. Another advantage of the present invention is that an Aerosil® gel-dispersed blue-phase liquid crystal simplifies the manufacturing process of electro-optical devices, such as LCDs, spatial light modulators, switchable LC lenses, active diffraction gratings and displays. Still another advantage of the present invention is that an Aerosil® gel-dispersed blue-phase liquid crystal material does not require alignment layers, is fast switching, and provides a wide viewing angle.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method of producing a blue-phase liquid crystal comprising the steps of:
providing a nematic liquid crystal material;
providing a chiral dopant material;
providing fumed metal-oxide nanoparticles; and
mixing the nematic liquid crystal material, the chiral dopant material and the fumed metal-oxide nanoparticles.

2. The method of claim 1, wherein the amount of the chiral dopant is from about 0.000001 to 90 parts by weight per 100 parts by weight of the nematic liquid crystal material.

3. The method of claim 2, wherein the amount of the fumed metal-oxide nanoparticles is from about 0.001 to about 10.0 parts by weight per 100 parts by weight of the nematic liquid crystal material and the chiral dopant.

4. The method of claim 1, wherein the fumed metal-oxide nanoparticles comprise semiconductor nanoparticles.

5. The method of claim 1, wherein the metal-oxide nanoparticles comprise silica nanoparticles.

6. The method of claim 1, wherein the fumed metal-oxide comprises Aerosil®.

7. The method of claim 1, wherein said chiral dopant comprises C15, CB15, CE1, CE2, CE4, CE5, CE6, CE9, S/R811, or S/R1011.

8. An electro-optical device comprising:
first and second substrates separated to define a gap between the substrates;
a liquid crystal composition disposed in the gap, the liquid crystal composition comprising a blend of nematic liquid crystals, at least one chiral dopant, and fumed metal-oxide nanoparticles; and
a pair of electrodes patterned on an inner surface of the first substrate to provide an electric field to switch the liquid crystal composition.

9. The electro-optical device of claim 8, wherein the at least one chiral dopant is in an amount of from about 5 to 90 parts by weight per 100 parts by weight of the nematic liquid crystals.

10. The electro-optical device of claim 9, wherein the fumed metal-oxide nanoparticles are in an amount from about 0.000001 to about 10 parts by weight per 100 parts by weight of the nematic liquid crystals.

11. The electro-optical device of claim 8, wherein said chiral dopant comprises C15, CB15, CE1, CE2, CE4, CE5, CE6, CE9, S/R811, or S/R1011.

12. The electro-optical device of claim 8, wherein fumed metal-oxide nanoparticles comprise silicon nanoparticles.

13. The electro-optical device of claim 8, wherein fumed metal-oxide nanoparticles comprise semiconductor nanoparticles.

14. The electro-optical device of claim 8, further comprising an electrically-driven liquid crystal spatial light modulator, a lens, a lens array, a photonic fiber, an active optical element, or a display.

15. The electro-optical device of claim 8, wherein the pair of electrodes comprises interdigitated electrodes.
